(19) United States
(12) Patent Application Publication
(10) Pub. No.: US 2019/0079168 A1
(43) Pub. Date: Mar. 14, 2019

(54) LIDAR LIGHT SOURCE

(71) Applicant: Shenzhen Genorivision Technology Co., Ltd., Shenzhen (CN)

(72) Inventors: Peiyan CAO, Shenzhen (CN); Yurun LIU, Shenzhen (CN)

(21) Appl. No.: 16/185,534

(22) Filed: Nov. 9, 2018

Related U.S. Application Data
(63) Continuation of application No. PCT/CN2017/075710, filed on Mar. 6, 2017.

(51) Int. Cl. G01S 7/481; G02F 1/295

(52) U.S. Cl. CPC G01S 7/4817; G01S 7/4818; G02F 2201/305; G02F 2203/24; G02F 2203/50; G02F 1/2955

(57) ABSTRACT

Disclosed herein is an apparatus suitable for generating a scanning light beam. The apparatus may comprise an electronic control system and a plurality of optical waveguides each comprising an optical core. The electronic control system may be configured to adjust dimensions of the optical cores of the plurality of optical waveguides by regulating temperatures of the optical cores of the plurality of optical waveguides, wherein by adjusting the dimensions of the optical cores of the plurality of optical waveguides the electronic control system is configured to control phases of output light waves from the plurality of optical waveguides for the output light waves to form a scanning light beam and control a direction of the scanning light beam.

### TECHNICAL FIELD

The disclosure herein relates to lidar light sources, particularly relates to a lidar light source with two-dimensional steering control.

### BACKGROUND

Lidar is a laser-based method of detection, range finding and mapping, which uses a technology similar to radar. There are several major components to a lidar system: laser, scanner and optics, photo detectors and receiver electronics. For example, controlled steering of scanning laser beams is carried out, and by processing the captured return signals reflected from distant objects, buildings and landscapes, distances and shapes of these objects, buildings and landscapes may be obtained.

Lidar is widely used. For example, autonomous vehicles (e.g., driverless cars) use lidar (also known as on-vehicle lidar) for obstacle detection and collision avoidance to navigate safely through environments. An on-vehicle lidar is mounted on the roof of a driverless car and it rotates constantly to monitor the current environment around the car. The lidar sensor provides the necessary data for software to determine where potential obstacles exist in the environment, help identify the spatial structure of the obstacle, distinguish objects based on size and estimate the impact of driving over it. One advantage of the lidar systems compared to radar systems is that the lidar systems can provide better range and a large field of view, which helps detecting obstacles on the curves. Despite tremendous progress has been made in lidar development in recent years, a lot of efforts are still being made these days to better design the lidar light sources to perform controlled scanning.

### SUMMARY

Disclosed herein is an apparatus, comprising: a plurality of optical waveguides each comprising an optical core; an electronic control system configured to adjust dimensions of the optical cores of the plurality of optical waveguides by regulating temperatures of the optical cores of the plurality of optical waveguides, wherein by adjusting the dimensions of the optical cores of the plurality of optical waveguides the electronic control system is configured to control phases of output light waves from the plurality of optical waveguides for the output light waves to form a scanning light beam and control a direction of the scanning light beam.

According to an embodiment, the plurality of optical waveguides forms a two-dimensional phased array and is configured to perform two-dimensional light scanning.

According to an embodiment, the plurality of optical waveguides is formed on a common substrate.

According to an embodiment, each of the plurality of optical waveguides is an optical fiber.

According to an embodiment, light waves of an input light beam to the plurality of optical waveguides are coherent.

According to an embodiment, the scanning light beam is a laser beam.

According to an embodiment, the apparatus further comprises a beam expander configured to expand an input light beam before the input light beam enters the plurality of optical waveguides.

According to an embodiment, the apparatus further comprises a diffraction grating configured to couple the light waves of the input light beam into the plurality of optical waveguides.

According to an embodiment, the diffraction grating is a microlens array.

According to an embodiment, at least one optical core comprises an optical medium that is conductive and transparent.

According to an embodiment, the at least one optical core is electronically connected to the electronic control system, wherein the electronic control system is configured to control the temperature of at least one optical core by applying an electric current flowing through the at least one optical core.

According to an embodiment, at least one of the plurality of optical waveguides further comprises a conductive cladding around sidewalls of a respective optical core.

According to an embodiment, the conductive cladding is electronically connected to the electronic control system, wherein the electronic control system is configured to control the temperature of the respective optical core by applying an electric current flowing through the conductive cladding.

According to an embodiment, the apparatus further comprises a Peltier device electrically connected to the electric control system, where in the electric control system is configured to control the temperature of at least one optical core by applying an electric current flowing through the Peltier device.

According to an embodiment, the apparatus further comprises a diffraction grating configured to modulate the scanning light beam.

According to an embodiment, the diffraction grating is a microlens array.

According to an embodiment, the diffraction grating is a Fresnel lens array.

According to an embodiment, at least one of the plurality of optical waveguides is embedded in one substrate and at least another of the plurality of optical waveguides is embedded in another substrate.

Disclosed herein is a system suitable for laser scanning, the system comprising: the apparatus of any one of the apparatuses above, a laser source, wherein the apparatus is configured to receive an input laser beam from the laser source and generate a scanning laser beam.

According to an embodiment, the system further comprises a detector configured to collect return laser signals after the scanning laser beam bounces off of an object.

According to an embodiment, the system further comprises a signal processing system configured to process and analyze the return laser signals detected by the detector.

### BRIEF DESCRIPTION OF FIGURES

FIG. 1 schematically shows an apparatus suitable for generating a two-dimensional scanned beam, according to an embodiment.

FIG. 2 schematically shows a cross-sectional view of an apparatus, according to an embodiment.

FIG. 3A schematically shows a top view of an apparatus, according to one embodiment.

FIG. 3B schematically shows a cross-sectional view of the apparatus in FIG. 3A, according to one embodiment.

FIG. 4A schematically shows a top view of an apparatus, according to another embodiment.

FIG. 4B schematically shows a cross-sectional view of the apparatus in FIG. 4A, according to another embodiment.

FIGS. 5A and 5B schematically show a top view and a cross-sectional view of an apparatus comprising a Peltier device, according to an embodiment.

FIG. 6 schematically shows a system suitable for laser scanning, according to an embodiment.

### DETAILED DESCRIPTION

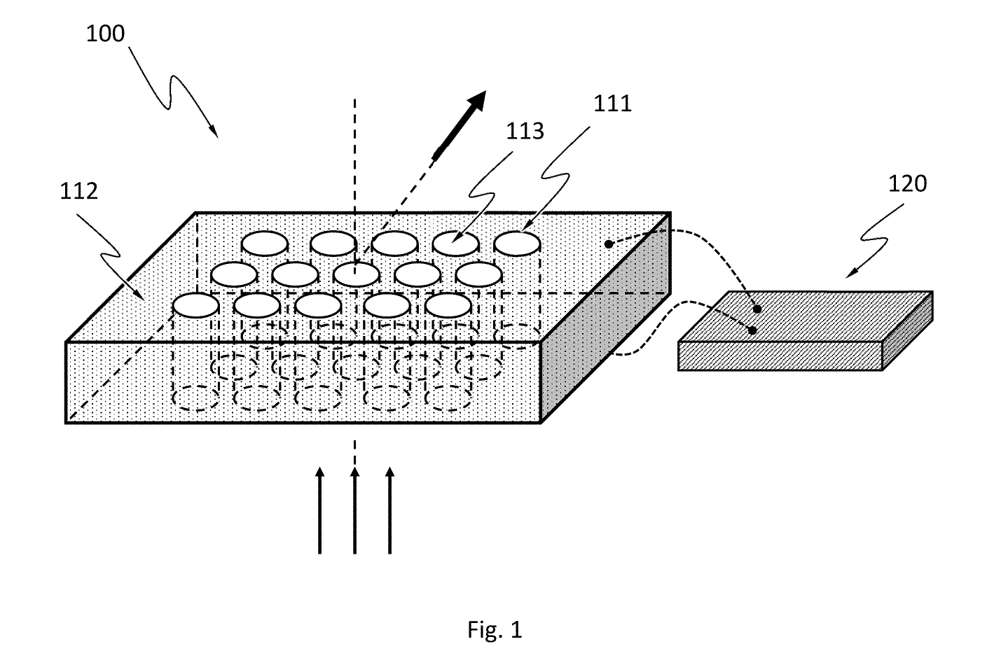

FIG. 1 schematically shows a perspective view of an apparatus 100 suitable for generating a two-dimensional scanned beam, according to an embodiment. The apparatus 100 may comprise a plurality of optical waveguides 111 and an electronic control system 120. In one embodiment, the plurality of optical waveguides 111 may be embedded in a substrate 112. The optical waveguides 111 may be optical fibers in one embodiment. In an embodiment, the plurality of optical waveguides 111 may form a one-dimensional array or a two-dimensional array such as a rectangular array, a honeycomb array, a hexagonal array or any other suitable array. In example of FIG. 1, the plurality of optical waveguides 111 may form a two-dimensional rectangular array and may be referred to as a two-dimensional phased array.

Each of the optical waveguides 111 may comprise an optical core 113 comprising an optical medium. In one embodiment, the optical medium may be transparent. Dimensions of each of the optical cores 113 may be individually adjusted by the electronic control system 120 to control phases of output light waves from respective optical cores 113. The electronic control system 120 may be configured to adjust the dimensions of each of the optical cores 113 by regulating the temperature of each of the optical cores 113.

When an input light beam incident on the optical cores 113, the light waves of the input light beam may pass through the optical cores 113 (e.g., by total internal reflection) and exit as output light waves from the plurality of optical waveguides 111. Diffraction may let the output light waves from each of the optical cores 113 spread over a wide angle so that when the input light waves are coherent (e.g., from a coherent light source such as a laser), the output light waves from the plurality of optical waveguides 111 may interfere with each other and exhibit an interference pattern. The electronic control system 120 may be configured to control phases of output light waves from the plurality of optical waveguides 111 for the interference pattern to generate a scanning light beam and steer the scanning light beam in one dimension or two dimensions. For example, the two-dimensional array of FIG. 1 may be controlled by the electronic control system 120 to generate a scanning light beam and perform two-dimensional light scanning (e.g., the scanning light beam may scan in the plane parallel to the upper surface of the substrate 112).

In one embodiment, the light waves of the input light beam to the plurality of optical waveguides 111 may be at a same phase. The interference pattern of the output light waves from the plurality of optical waveguides 111 may comprise one or more propagating bright spots where output light waves constructively interfere (e.g., re-enforce) and one or more propagating weak spots where output light waves destructively interfere (e.g., cancel out each other). In one embodiment, the one or more propagating bright spots may form one or more scanning light beams generated by the apparatus 100. If the phases of the output light waves of the optical cores 113 shift and the phase differences between the output light waves change, the constructive interferences may happen at different directions so that the interference pattern of the output light waves (e.g., the directions of the one or more generated scanning light beams) may also change. In other words, light beam steering may be realized by adjusting the phases of the output light beams from the plurality of optical waveguides 111.

One way of adjusting the phases of the output light waves is changing the effective optical paths of the input light waves propagated through the optical cores 113. An effective optical path of a light wave propagated through an optical medium may depend on the physical distance the light travels in the optical medium (e.g., depending on incident angle of the light wave, dimensions of the optical medium). As a result, the electronic system 120 may adjust the dimensions of the optical cores 113 to change the effective optical paths of incident light beam propagates through the optical cores 113 so that the phases of the output light waves shift under the control of the electronic control system 120. For example, the length of each of the optical cores 113 may change because at least a part of the respective optical cores 113 has a temperature change. Moreover, the diameter of at least a section of an optical core 113 may change if at least part of the section of the optical core 113 has a temperature change. Therefore, in one embodiment, regulating the temperature of each of the optical cores 113 may be used to control the dimensions of the optical cores 113 due to the thermal expansion or contractions of the optical cores 113.

In one or more embodiments, the optical waveguides 111 need not to be straight. For example, some or all of them may be curved (e.g., “U” shaped, “S” shaped, etc.). The cross-sectional shape of the optical waveguides 111 may be a rectangle, circle, or any other suitable shape. In an embodiment, the substrate 112 may include conductive, non-conductive or semiconductor materials. In an embodiment, the substrate 112 may include a material such as silicon dioxide. In one or more embodiments, one or more optical waveguides 111 may be embedded in one substrate by filling one or more holes formed on the substrate with the optical medium. The one or more holes on the substrate may be formed by laser drilling, chemical etching, etc. A polishing process may be employed to remove a portion of the substrate covering the bottom of each of the one or more holes and polish two ends of each of the one or more optical waveguides 111 after the embedding process. Moreover, in one or more embodiments, the optical waveguides 111 need not to be embedded in one substrate. For example, some optical waveguides 111 may be embedded in one substrate; some other optical waveguides 111 may be embedded in a separate substrate.

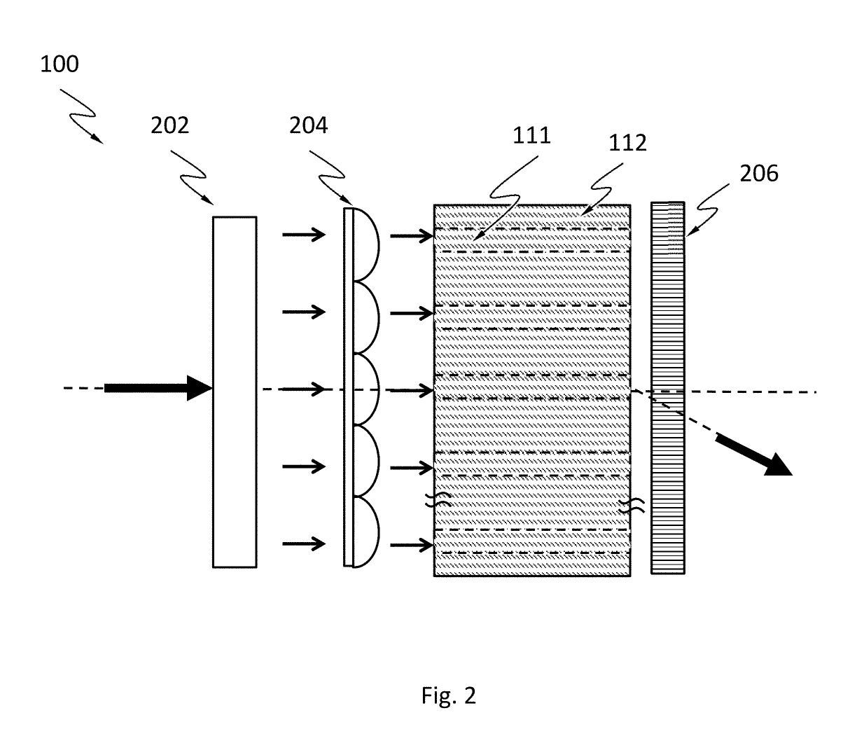

FIG. 2 schematically shows a cross-sectional view of the apparatus 100, according to an embodiment. The apparatus 100 may further comprise a beam expander 202 (e.g., a group of lenses). The beam expander 202 may expand the input light beam before the input light beam enters the plurality of optical waveguides 111. The plurality of optical waveguides 111 is shown in dashed line because they are not directly visible in this view. The expanded input light beam may be collimated. In an embodiment, the apparatus 100 may further comprise a diffraction grating (e.g., a microlens array 204) configured to converge and couple the light waves of the input light beam into the plurality of optical waveguides 111. The apparatus 100 may further comprise one or more diffraction gratings 206 (such as microlens array or Fresnel lens array) configured to modulate the output light waves from the plurality of optical waveguides 111.

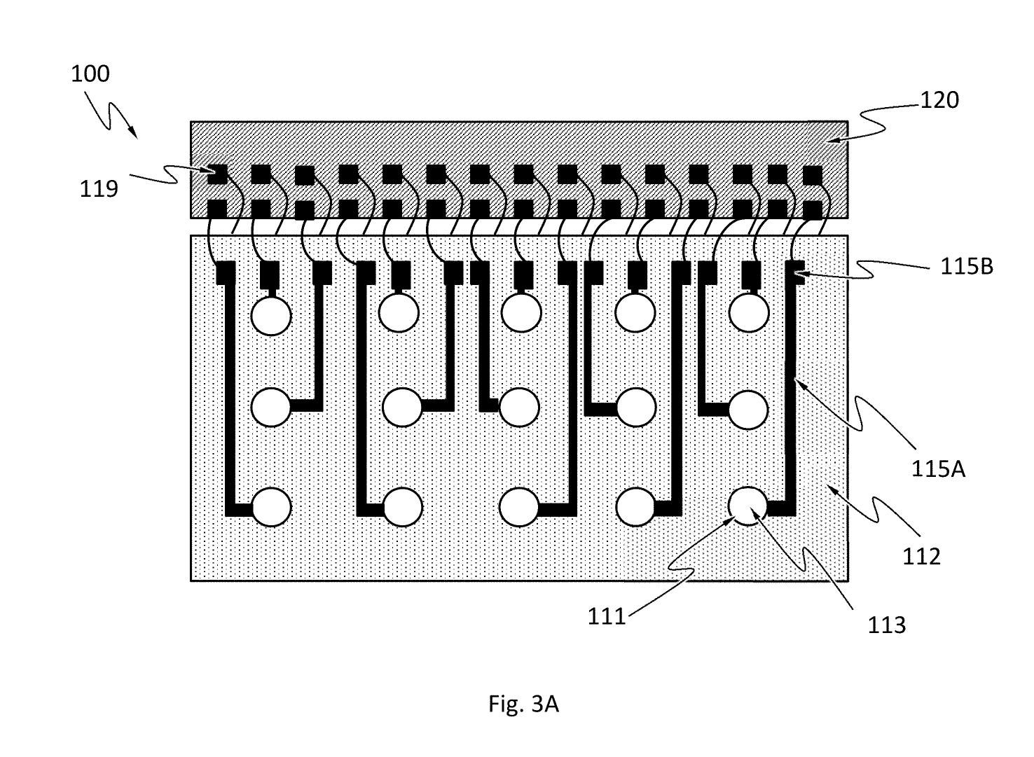

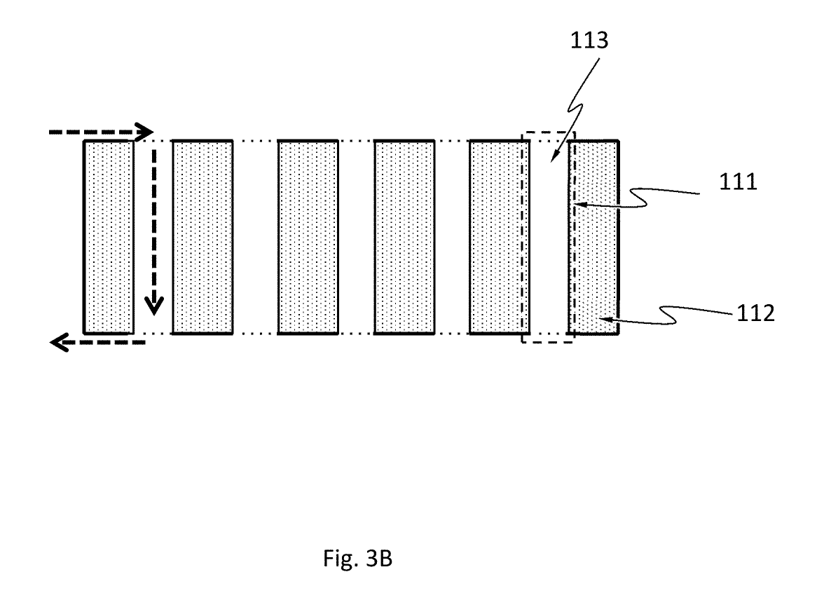

FIG. 3A and FIG. 3B schematically show a top view and a cross-sectional view of the apparatus 100, according to one embodiment. As shown in FIG. 3A and FIG. 3B, each of the optical cores 113 may comprise an optical medium that is conductive and transparent. The optical cores 113 may be electrically connected to the electronic control system 120. In an embodiment, the electronic control system 120 may be configured to individually adjust the dimensions of each of the optical cores 113 by individually regulating the temperature of each of the optical cores 113. The electronic control system 120 may apply an electric current to each of the optical cores 113 respectively. The temperature of each of the optical cores 113 may be individually regulated by controlling the magnitude of the electric current flowing through each of the optical cores 113. As shown in FIG. 3B, an electric current (dashed arrow) is flowing through an optical core 113. In example of FIG. 3A, the substrate 112 may comprise routing elements (such as routing vias and electronic contacts 115A and 115B) connecting to some of the optical cores 113. The electronic control system 120 may comprise electric contacts 119. The plurality of optical waveguides 111 may be electronically connected to the electric contacts 119. The electric connection between the plurality of optical waveguides 111 and the electronic control system 120 may be realized by wire bonding or using an interposer.

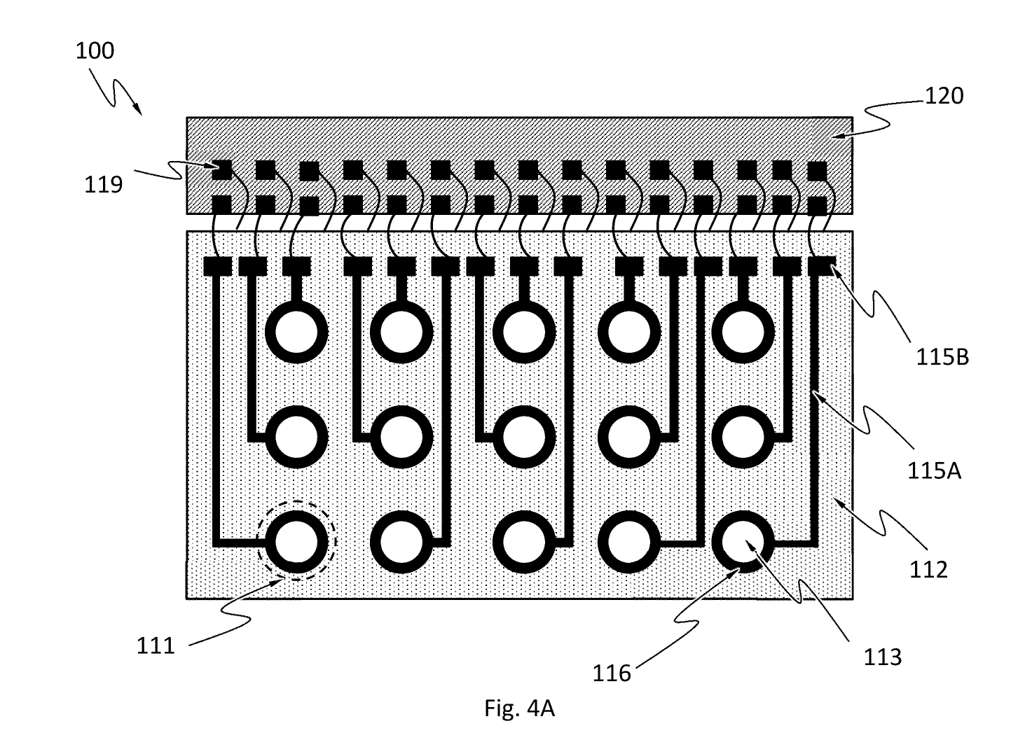

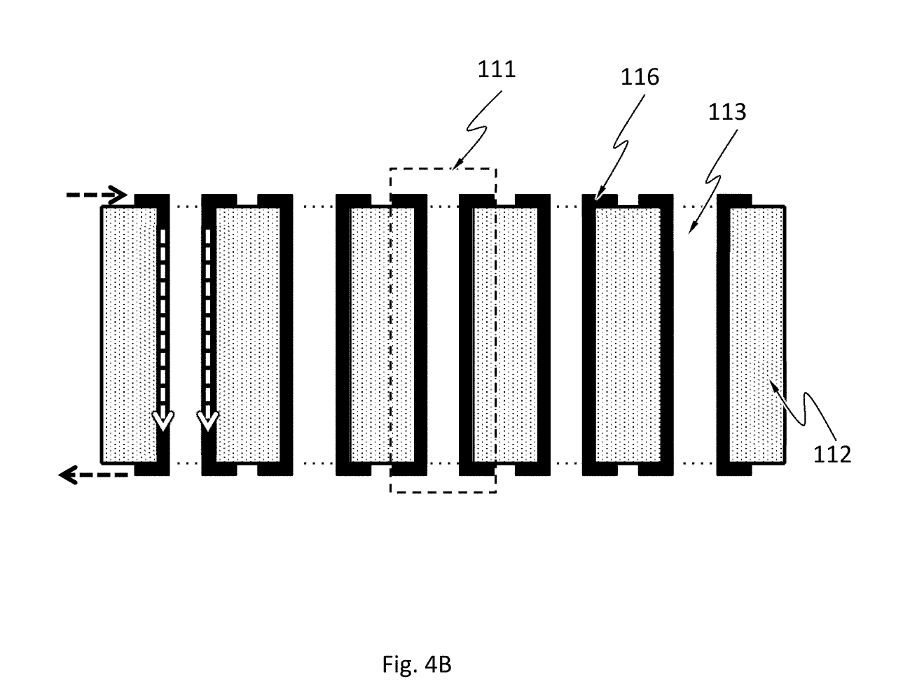

FIG. 4A and FIG. 4B schematically show a top view and a cross-sectional view of the apparatus 100, according to another embodiment. As shown in FIG. 4A and FIG. 4B, each of the optical waveguides 111 may comprise a conductive cladding 116 around sidewalls of a respective optical core 113. In an embodiment, each of the conductive claddings 116 may be electronically connected to the electronic control system 120 through routing elements (such as routing vias and electronic contacts 115A and 115B) and electric contacts 119. The electronic control system 120 may be configured to individually adjust the dimensions of each of the optical cores 113 by regulating the temperature of each of the optical cores 113. The electronic control system 120 may apply an electric current to each of the conductive cladding 116. The temperature of each of the optical cores 113 may be regulated individually by controlling the magnitude of each of the electric current flowing through each of the respective conductive cladding 116 due to heat transfer between the optical core 113 and the respective conductive cladding 116. As shown in FIG. 4B, an electric current (dashed arrow) is flowing through a conductive cladding 116.

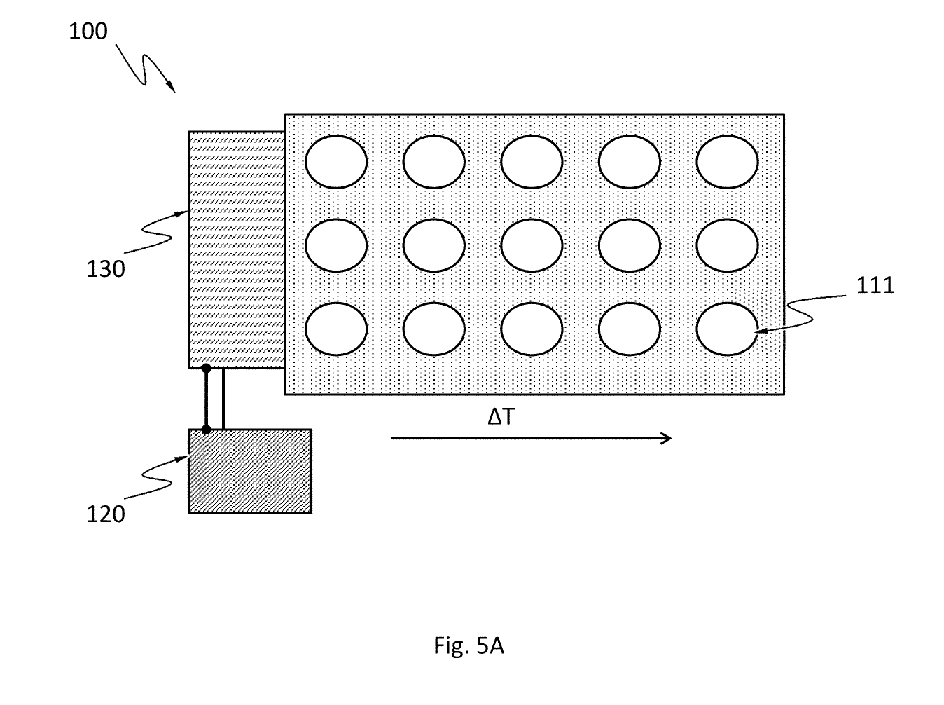

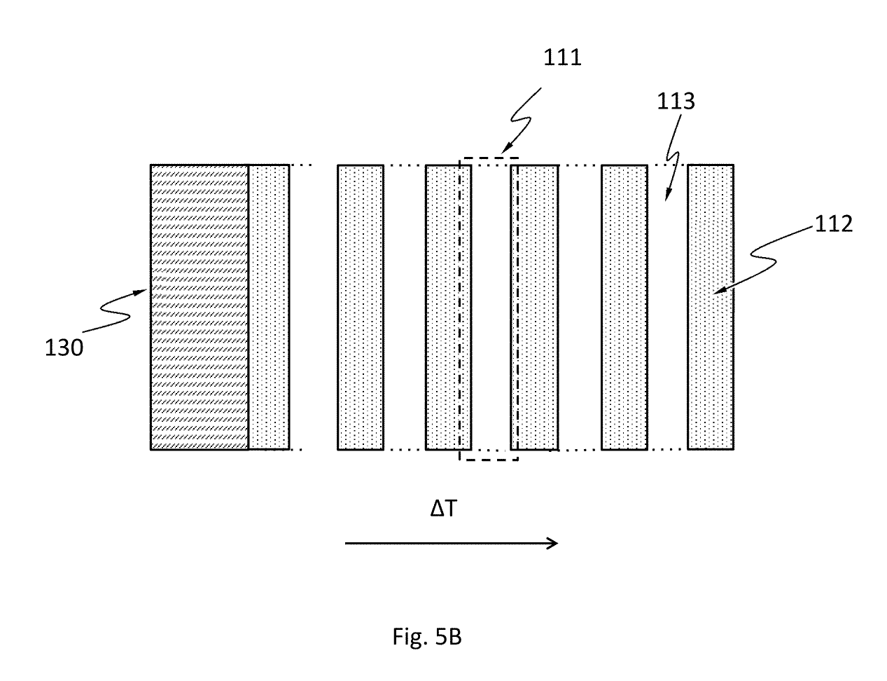

FIGS. 5A and 5B schematically show a top view and a cross-sectional view of the apparatus 100, according to an embodiment. In this embodiment, the apparatus 100 may comprise one or more Peltier devices 130. A Peltier device 130 is a semiconductor based electronic component capable of converting a voltage or current input into a temperature difference that may be used for either heating or cooling. For example, when a current is applied to the Peltier device 130, one side of the Peltier device 130 is cooled down, and the other side of the Peltier device 130 is heated up. In an embodiment, one or more Peltier devices are electronically connected to the electronic control system 120. One side (either cold side or hot side) of each of the Peltier devices is in contact with a sidewall of the substrate 112. The electronic control system 120 may apply an electric current to each of the Peltier devices 130. The temperature of each of the optical cores 113 may be regulated by controlling the magnitude and direction of each of the electric current flowing through each of the Peltier devices 130 due to heat transfer between the plurality of optical waveguides 111 and the Peltier devices 130. In one embodiment, the Peltier devices may share a common substrate with the plurality of optical waveguides 111. In example of FIG. 5A and FIG. 5B, the apparatus 100 comprises one Peltier device 130 in contact with one sidewall of the substrate 112, and a temperature gradient may be achieved across the substrate 112. In another embodiment, more than one sidewalls of the substrate 112 may be in contact with Peltier devices.

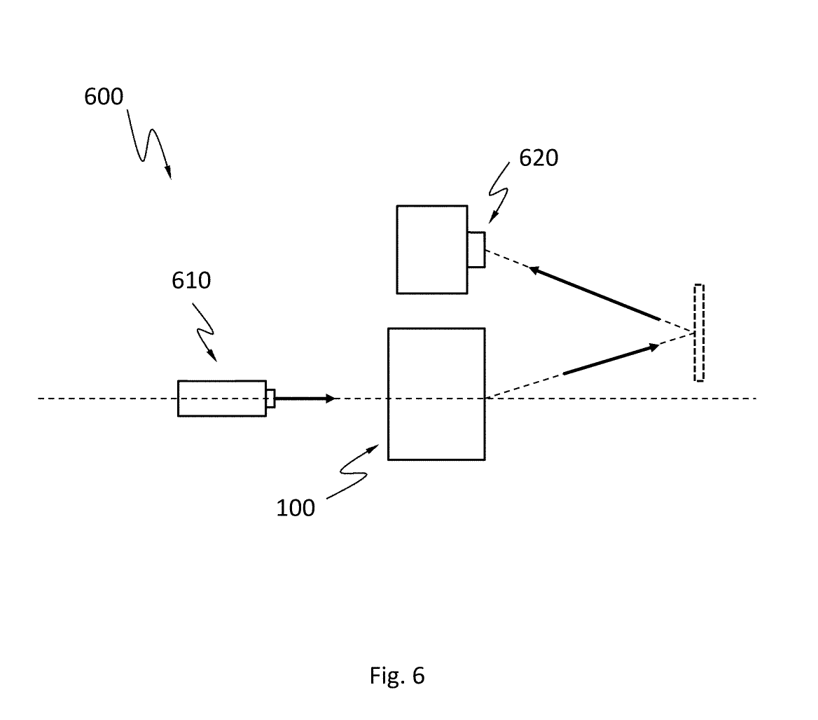

FIG. 6 schematically shows a system 600 suitable for laser scanning, according to an embodiment. The system 600 comprises a laser source 610 and an embodiment of an apparatus 100 described herein. The apparatus 100 is configured to receive an input laser beam from the laser source 610 and may generate a scanning laser beam due to light diffraction and interference. In an embodiment, the system 600 may perform two-dimensional laser scanning without moving part. The system 600 may be used together with a detector 620 and a signal processing system in a Lidar system (e.g., an on-vehicle Lidar). The detector 620 is configured to collect return laser signals after the scanning laser beam bounces off of an object, building or landscape. The signal processing system is configured to process and analyze the return laser signals detected by the detector. In one embodiment, the distance and shape of the object, building or landscape may be obtained.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus, comprising:
a plurality of optical waveguides each comprising an optical core; and
an electronic control system configured to adjust dimensions of the optical cores of the plurality of optical waveguides by regulating temperatures of the optical cores of the plurality of optical waveguides, wherein by adjusting the dimensions of the optical cores of the plurality of optical waveguides the electronic control system is configured to control phases of output light waves from the plurality of optical waveguides for the output light waves to form a scanning light beam and control a direction of the scanning light beam.

2. The apparatus of claim 1, wherein the plurality of optical waveguides forms a two-dimensional phased array and is configured to perform two-dimensional light scanning.

3. The apparatus of claim 1, wherein the plurality of optical waveguides is formed on a common substrate.

4. The apparatus of claim 1, wherein each of the plurality of optical waveguides is an optical fiber.

5. The apparatus of claim 1, wherein light waves of an input light beam to the plurality of optical waveguides are coherent.

6. The apparatus of claim 1, wherein the scanning light beam is a laser beam.

7. The apparatus of claim 1, further comprising a beam expander configured to expand an input light beam before the input light beam enters the plurality of optical waveguides.

8. The apparatus of claim 1, further comprising a diffraction grating configured to couple the light waves of an input light beam into the plurality of optical waveguides.

9. The apparatus of claim 8, wherein the diffraction grating is a microlens array.

10. The apparatus of claim 1, wherein at least one optical core comprises an optical medium that is conductive and transparent.

11. The apparatus of claim 10, wherein the at least one optical core is electronically connected to the electronic control system, wherein the electronic control system is configured to control a temperature of at least one optical core by applying an electric current flowing through the at least one optical core.

12. The apparatus of claim 1, wherein at least one of the plurality of optical waveguides further comprises a conductive cladding around sidewalls of a respective optical core.

13. The apparatus of claim 12, wherein the conductive cladding is electronically connected to the electronic control system, wherein the electronic control system is configured to control a temperature of the respective optical core by applying an electric current flowing through the conductive cladding.

14. The apparatus of claim 1, further comprising a Peltier device electrically connected to the electric control system, where in the electric control system is configured to control a temperature of at least one optical core by applying an electric current flowing through the Peltier device.

15. The apparatus of claim 1, further comprising a diffraction grating configured to modulate the scanning light beam.

16. The apparatus of claim 15, wherein the diffraction grating is a microlens array.

17. The apparatus of claim 15, wherein the diffraction grating is a Fresnel lens array.

18. The apparatus of claim 1, wherein at least one of the plurality of optical waveguides is embedded in one substrate and at least another of the plurality of optical waveguides is embedded in another substrate.

19. A system suitable for laser scanning, the system comprising:
the apparatus of claim 1,
a laser source,
wherein the apparatus is configured to receive an input laser beam from the laser source and generate a scanning laser beam.

20. The system is claim 19, further comprising a detector configured to collect return laser signals after the scanning laser beam bounces off of an object.

21. The system of claim 20, further comprising a signal processing system configured to process and analyze the return laser signals detected by the detector.
